(19) United States
(12) Patent Application Publication
(10) Pub. No.: US 2023/0016859 A1
(43) Pub. Date: Jan. 19, 2023

(54) Multi-Pivot Partial Quicksort and Oblivious Comparisons of Secret Shared Arithmetic Values in a Multi-Party Computing Setting

(71) Applicant: Inpher, Inc., NEW YORK, NY (US)

(72) Inventors: Kevin Deforth, Lausanne (CH); Nicolas Gama, Lausanne (CH); Mariya Georgieva, Nanterre (FR); Dimitar Jetchev, St-Saphorin-Lavaux (CH)

(21) Appl. No.: 17/578,274

(22) Filed: Jan. 18, 2022

Related U.S. Application Data
(63) Continuation-in-part of application No. 17/464,600, filed on Sep. 1, 2021, now abandoned.
Application No. 17/464,600 is a continuation-in-part of application No. 17/374,956, filed on Jul. 13, 2021, now abandoned.
(60) Provisional application No. 63/051,317, filed on Jul. 13, 2020.
(60) Provisional application No. 63/073,419, filed on Sep. 1, 2020.

(51) Int. Cl. H04L 9/08

(52) U.S. Cl. CPC H04L 9/085; H04L 9/0869; H04L 2209/46

(57) ABSTRACT

A secure multi-party computing system performs a multi-pivot partial sorting operation on a secret shared array of values. The use of multiple pivots supports efficient computations in a multi-party computation setting. Partial sorting determines percentile values without the need for a full sort. The secret shared array is first permuted by a secret random permutation. A multi-pivot sort, which can be a partial sort, is performed on the permuted array to obtain a public sorting permutation. The multi-pivot sort uses oblivious comparisons that produce secret shared Boolean indications of whether one secret shared value is less than another. The Boolean indications are revealed and used to produce the public sorting permutation, which in turn, is applied to the secret random permutation to obtain a secret shared sorting permutation. The secret shared sorting permutation is then applied to the secret shared array to obtain a sorted secret shared result.

### RELATED APPLICATIONS

The subject matter of this application is related to U.S. patent application Ser. No. 17/464,600, filed on 2021 Sep. 1, U.S. patent application Ser. No. 17/374,956, filed on 2021 Jul. 13, U.S. patent application Ser. No. 17/093,008, filed on 2020 Nov. 9, now U.S. patent Ser. No. 11/050,558, U.S. Provisional Application No. 63/073,419, filed on 2020 Sep. 1, U.S. patent application Ser. No. 16/937,310, filed on 2020 Jul. 23, now U.S. patent Ser. No. 10/917,235, and U.S. Provisional Application No. 63/051,317, filed on 2020 Jul. 13 all of which applications are hereby incorporated by reference in their entireties.

### BACKGROUND OF THE INVENTION

Privacy-preserving multi-party computation (MPC) techniques enable multiple parties to collaboratively evaluate a function to produce a shared or revealed output while keeping the inputs private. Such computations are used, for example, in medicine and finance, when the input data comes from distinct private data sources that cannot disclose their data, but a public result based on the confidential data is needed.

A MPC is generally split both temporally and geographically across multiple participants. The participants, each of which represents a separate computing system, typically include k parties and one trusted dealer or honest-but-curious dealer. As used herein, the terms party and player are used interchangeably and refer to individual party computer systems participating in a multi-party computation.

After compilation of code to implement the computation, the dealer first executes an offline phase of the MPC. In the offline phase, the dealer produces masks (masking data, also referred to as triplets), and distributes shares of these masks to the parties such that each party knows only its share of the mask and none of them know the plaintext mask value represented by a sum of the shares. The determination of the masks typically depends on the data expected to be operated upon from statistical analysis perspective so that the masks are appropriately configured in relation to the data.

The k parties then collaboratively execute an online phase of the MPC, with synchronization steps where parties can exchange or broadcast messages according to a defined MPC protocol. The online phase can be run in a firewalled environment to which the dealer has no access.

A MPC can be the distributed equivalent of a plaintext pseudocode, which we can describe as a single static assignment (SSA) graph of MPC-friendly elementary operations. The nodes of the SSA graph are plaintext variables, and each party gets a local view (or secret share) of the variables. We denote this local view as an MPC container. The MPC-friendly elementary operations are referred to as builtins that take MPC containers and optionally some static parameters, as input and produce MPC containers as output.

FIG. 1 illustrates a schematic of MPC containers for k parties of a multi-party computation. Globally, a MPC container holds all the information about one variable in the SSA, namely, a plaintext value x that can be either public (known by all parties, but not the dealer) or a secret shared [symbol] x [symbol] (each party knows its share only), one mask [symbol] λ [symbol] (known by the dealer, and secret shared among all parties), and the optional masked value a=x+λ (known by all parties, but typically not the dealer). Notation note: the double square bracket notation [symbol] [symbol] is used herein to denote a secret shared value.

Locally, each party has a trace of the MPC container, which can be a structure with fields as follows:
the public value x (if the container is publicly revealed)
one share xⱼ of the public value
one share λⱼ of the container's mask
the masked value a (if the container is masked and revealed).

Analyzing the union of the k containers, the following holds: the plaintext value of the container is by definition the sum of all shares Σxⱼ, if the container is public, all parties know the plaintext value, and each party has this value x populated. In this case, none of the other fields need be used in the MPC protocol. The mask of the container is λ=Σλⱼ. The value of the mask is known only by the dealer (during the offline phase). None of the parties knows or learns the actual mask during the online phase. The masked value a is equal to λ+x. The special mask-and-reveal operation instructs each party to broadcast its xⱼ+λⱼ, which allows them to jointly reconstruct and store the same field a=x+λ. All other technical or local variables that appear in the builtins are called ephemeral variables.

Although multi-party computations may be described herein with reference to a multi-party computing system that includes a dealer computer system, such computations can be generally performed without using a dealer computer system using alternative known techniques. While such implementations are contemplated by the present disclosure, they may be less efficient than implementations that include a dealer computer system.

### SUMMARY OF THE INVENTION

Disclosed methods can be performed by a secure multi-party computing system configured for performing multi-party computations on secret shared values. The secure multi-party computing system can include a plurality of party computing systems in secure networked communication. The secure multi-party computing system can optionally include a dealer computer system, which can be a trusted dealer.

A method performs a sorting operation on a secret shared array z of values, the array z having N elements. The method can include: each of the party computing systems storing a respective secret share of the array z; generating a secret random permutation σ of size N; secret sharing the secret random permutation σ across the party computing systems; the party computing systems applying the secret random permutation σ to the array z to obtain a permuted secret shared array v; the party computing systems performing a set of operations on the array v to produce a public sorting permutation P of the permuted secret shared array v, the set of operations including multi-party computations; the party computing systems applying the public sorting permutation P to the secret random permutation σ to obtain a secret shared sorting permutation πr; and the party computing systems applying the secret shared sorting permutation π to the array z; to obtain an array \hat{z} representing the array z permuted according to the sorting operation.

The method can further include: accessing a maximum comparison quantity representing a maximum quantity of pairs of secret shared values configured to be simultaneously compared by the multi-party computing system through an oblivious comparison process, wherein the set of operations comprises a subset of operations comprising: for a set of one or more intervals I, wherein each interval I represents a portion of the array v, determining, based on the maximum comparison quantity, a quantity of pivots n_{I} for each interval I; and for at least one of the set of intervals I: selecting a set of pivots from the interval I based on the determined quantity of pivots n_{I}; selecting a set of non-pivots by excluding the selected set of pivots from the interval I; performing oblivious comparisons of: each of the set of pivots with each of the set of non-pivots, and each of the set of pivots with all others of the set of pivots; and based on the oblivious comparisons, determining a permutation P_{I} of the elements of the interval I that places: each of the pivots is in its proper sorted location within the array v, and each of the non-pivots among a contiguous group of non-pivots interleaved adjacent one or two pivots within the array v, wherein all members of the contiguous group bear a common comparison relationship to each adjacent pivot.

The method can be performed such that for at least one particular interval of the set of one or more intervals I, the determined quantity of pivots n_{I} for the particular interval represents all elements of the particular interval, and wherein the subset of operations further comprises, for the particular interval: selecting all elements of the particular interval as a set of pivots; performing oblivious comparisons of: each of the set of pivots with all others of the set of pivots; and based on the oblivious comparisons, determining a permutation P_{I} of the elements of the interval I that places: each of the pivots is in its proper sorted location within the array v.

The method can be performed such that the set of operations further comprises: iterating, one or more times, the subset of operations wherein each interval I of a current iteration represents a contiguous group of non-pivots from a prior iteration.

The method can be performed such that the set of one or more intervals I represents a proper subset of the set of contiguous groups of non-pivots from a prior iteration.

The method can be performed such that the sorting operation is a partial sorting operation that does not fully sort the array z.

The method can be performed such that the permutation π produced by the partial sorting operation places elements for a set of one or more target indices of the array z in their proper locations in the partially sorted array \hat{z}.

The method can be performed such that the target indices are determined based on an input parameter defining a quantity of substantially equally sized segments into which the array v can be divided.

The method can further include: in response to determining that a particular contiguous group of non-pivots from a prior iteration does not contain at least one target index, excluding the particular contiguous group of non-pivots from the set of one or more intervals I of a current iteration.

The method can be performed such that the secret sharing of the secret random permutation σ across the party computing systems is performed using a Benes network.

The secure multi-party computing system can further include a dealer computing system that performs: generating a secret random permutation σ of size N; and secret sharing the secret random permutation σ across the party computing systems.

The method can be performed such that each of the oblivious comparisons comprises the secure multi-party computing system determining a secret shared indication of whether a secret shared numerical value a is less than a secret shared numerical value b, wherein multiple comparisons are performed simultaneously in a set of up to the maximum comparison quantity of comparisons, and wherein the secret shared indications are revealed after each set of comparisons.

The method can be performed such that the determining a secret shared indication includes: each of the party computing systems storing a respective secret share of each of the values a and b; each of the party computing systems subtracting its secret share of b from its secret share of a to compute a respective secret share of a secret shared numerical value c; performing a first set of multiparty computations in order to decompose the secret shared numerical value c into a public Boolean array of bits C, representing the value c in a masked Boolean form, and a secret shared Boolean array ∧ representing a mask for the array C; each of the party computing systems determining and storing a secret shared Boolean array of bits R, the array R comprising results of a bitwise (C OR ∧) operation performed on portions of the arrays C and ∧; performing a second set of multiparty computations sufficient to execute a bit-wise addition of the array ∧ to the array C using the array R, wherein the bit-wise addition propagates carry bits from less significant bit positions to more significant bit positions up to a most significant secret shared bit; and each of the party computing systems storing a respective secret share of the most significant secret shared bit as the secret shared indication.

The method can be performed such that the second set of multiparty computations is performed using fewer rounds of communication than a total number of bits in the array C.

The method can be performed such that the second set of multiparty computations is performed using order log(total number of bits in the array C) rounds of communication.

An oblivious comparison method takes as input two secret shared numerical values x and y and outputs a secret shared bit that is the result of the comparison of x and y (e.g. 1 if x<y and 0 otherwise). The method uses secure multi-party computation, allowing multiple parties to collaboratively perform the comparison while keeping the inputs private and revealing only the result. The two secret shared values are subtracted to compute a secret shared result, the sign of which indicates the result of the comparison. The method decomposes the secret shared result into a masked Boolean representation and then performs a bit-wise addition of the mask and the masked result. Through the bit-wise addition the method can extract a secret shared representation of the most significant bit, which indicates the sign of the result, without revealing the result itself.

A method determines a secret shared indication of whether a secret shared numerical value a is less than a secret shared numerical value b. The method can be performed by a secure multi-party computing system configured for performing multi-party computations on secret shared values, the secure multi-party computing system including a dealer computing system and a plurality of party computing systems in secure networked communication. The method includes: each of the party computing systems storing a respective secret share of each of the values a and b; each of the party computing systems subtracting its secret share of b from its secret share of a to compute a respective secret share of a secret shared numerical value c; the dealer computing system and the plurality of party computing systems performing a first set of multiparty computations in order to decompose the secret shared numerical value c into a public Boolean array of bits C, representing the value c in a masked Boolean form, and a secret shared Boolean array ∧ representing a mask for the array C; each of the party computing systems determining and storing a secret shared Boolean array of bits R, the array R comprising results of a bitwise (C OR ∧) operation performed on portions of the arrays C and ∧; the dealer computing system and the plurality of party computing systems performing a second set of multiparty computations sufficient to execute a bit-wise addition of the array ∧ to the array C using the array R, wherein the bit-wise addition propagates carry bits from less significant bit positions to more significant bit positions up to a most significant secret shared bit; and each of the party computing systems storing a respective secret share of the most significant secret shared bit as the secret shared indication.

The method can be performed such that the second set of multiparty computations is performed using fewer rounds of communication than a total number of bits in the array C. The method can be performed such that the second set of multiparty computations is performed using order log(total number of bits in the array C) rounds of communication. The dealer can be a trusted dealer or an honest but curious dealer.

A multi-party computing system can be configured to perform any one or more of the foregoing methods.

A non-transitory computer readable medium can be encoded with instructions, wherein the instructions are executed by a multi-party computing system to cause the multi-party computing system to perform any one or more of the foregoing methods.

As will be appreciated by one skilled in the art, multiple aspects described in this summary can be variously combined in different operable embodiments. All such operable combinations, though they may not be explicitly set forth in the interest of efficiency, are specifically contemplated by this disclosure.

### BRIEF DESCRIPTION OF THE DRAWINGS

FIG. 1 illustrates a schematic of MPC containers for k parties of a multi-party computation.

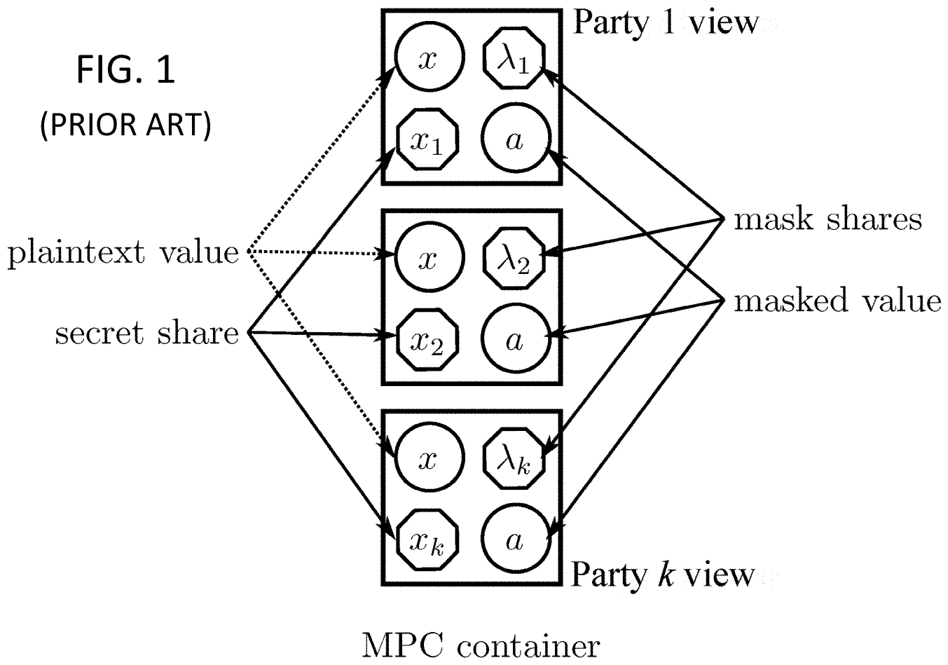

FIG. 2A illustrates pseudocode for the classical Lomuto partition scheme.

FIG. 2B illustrates pseudocode for the classical Quicksort method.

FIG. 3 illustrates a main procedure, referred to as Multi-pivot partial quicksort (MPPQ).

FIG. 4 illustrates a MPPQ-aux auxiliary recursive procedure.

FIG. 5 illustrates an assign_pivots procedure.

FIG. 6 illustrates a sorting_perm_and_split procedure.

FIG. 7 illustrates a generate_comparison_vectors procedure.

FIG. 8 illustrates pseudo-code for a naïve implementation of an oblivious comparison method.

FIG. 9 illustrates a divide and conquer implementation of an oblivious comparison method.

FIG. 10 illustrates a general computer architecture that can be appropriately configured to implement components disclosed in accordance with various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

### I. MULTI-PIVOT PARTIAL QUICKSORT

We present a privacy-preserving method for binning, Multi-pivot Partial Quicksort (MPPQ) in the secure multi-party computation (MPC) setting that takes as input a private array as well as an integer B and outputs secret shares of the B-percentiles of the array as well as a secret shared permutation that partially sorts the array according to the B bins determined by the B-percentiles while keeping the input array secret.

In one embodiment, the method can be implemented using the XOR Secret Computing Engine developed by Inpher, adopting the full-threshold model for MPC throughout and splitting the computation into online and online phases. The offline phase (independent of the input data) can be performed by a trusted dealer or honest-but-curious dealer. Although the methods disclosed herein may in some cases be described with respect to the trusted dealer model, these methods can also be used with the honest but curious model.

### 1. Introduction

One of the major challenges with efficient oblivious sorting and binning methods in the MPC setting has been the fact that the two most efficient sorting methods, merge sort and quicksort, are data dependent. Efforts have been made to design oblivious versions of these two methods [7] (implementing Batcher's merge sort on Sharemind's system [2]), [6], [5] (the latter combining [2], [6] and Batcher sorting networks).

Here, we discuss a quicksort variant implemented on the Manticore framework developed by Inpher [3]. Using an idea that already appears in prior work (e.g. [6], [5]), we first make all elements unique by appending a least significant counter tag of log₂ N bits to the elements of the original (secret shared) array, then we shuffle the array by applying a trusted dealer-generated secret shared random permutation. We then perform (obliviously) the comparisons of the quicksort method on the shuffled array and reveal the Boolean outputs at each iteration. The uniformly random permutation ensures that no information is leaked about the relative order of the elements in the original array.

Shuffling the original vector represents only a minor time overhead in quicksort. To apply the dealer-generated permutation, we choose between two implementations: if the number of players is large (k≥log₂ N) we use a Benes network [4, 8] where the dealer picks a uniformly random permutation, routes it, and secret-shares the Boolean network switches. This enables parallelizable shuffling (using the network) within exactly 2·log N rounds of element-wise products of size N. Yet, when the number of players is small (k≤log₂ N), we use a simpler protocol inspired by [5]. Here, during the offline phase the trusted dealer sends one permutation to each player while during the online phase, the players simply evaluate the composition of these permutations in exactly k rounds of secret permutation.

Another key idea for our implementation is the concept of multi-pivots: recall that quicksort is a recursive procedure that, in its most basic form, chooses an element of the array (a pivot) and first permutes the elements according to the pivot (the smaller ones being on the left and the larger ones being on the right of the pivot), thus partitioning the array into two subarrays. It then calls itself on the two subarrays. The worst case of the method thus occurs for highly unbalanced partitions (one of the sets has many more elements than the other one). The random permutation applied in the beginning can address this issue on average. In order to further reduce the variance on the expected depth of the method, we partition the array into more than two sets by using more than one pivot and parallel oblivious comparisons. Unlike plaintext sorting where sequential comparisons do not become the bottleneck, the more expensive oblivious comparisons benefit from batching/parallelization, thus, making multiple pivots particularly useful [1]. Since the number of rounds of communication is proportional to the depth, the multi-pivot approach provides a heuristically faster method.

Overall, the method runs in O(b·log₂ N) communication rounds where b is the bit-size of each element of the array and N is the number of elements. The Benes network requires 2˜log₂ N communication rounds of complexity N/2 each whereas the composition protocol requires k communication rounds of complexity N each, where k is the number of players. Moreover, quicksort runs in (heuristically) log₂ N comparison rounds.

To facilitate the exposition, the (MPC-friendly) plaintext version of our method MPPQ is outlined in Section 2. We explain how to adapt each step to the MPC setting in Section 3.

1.1 Classical Lomuto Quicksort

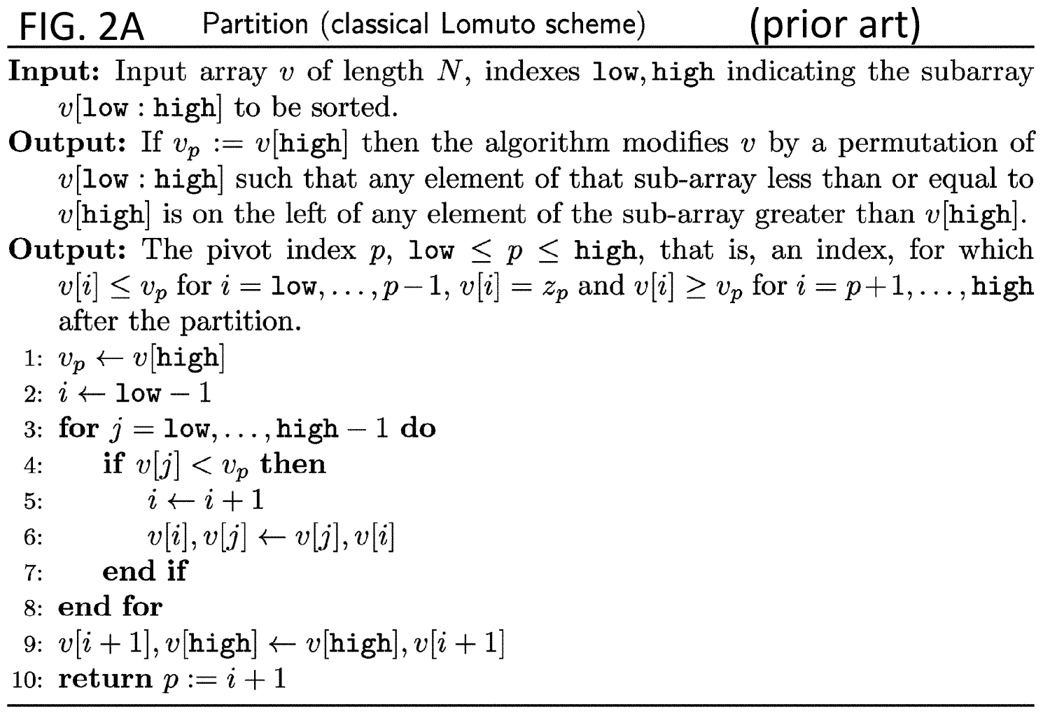

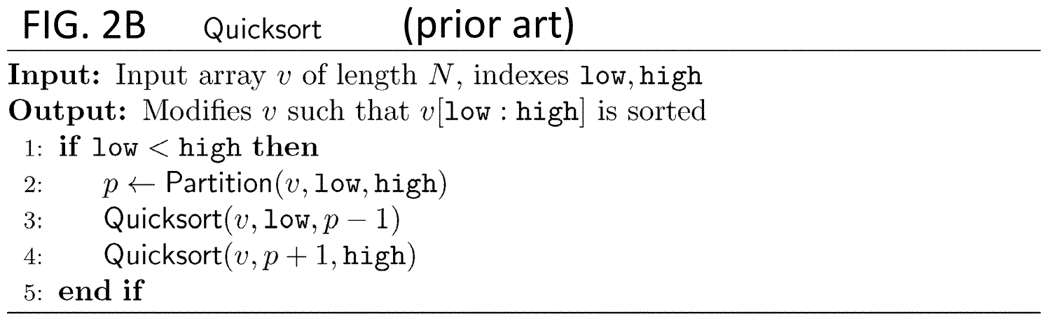

FIGS. 2A and 2B illustrate pseudocode for, respectively, the well-known prior art partition procedure according to the classical Lomuto partition scheme, and the classical Quicksort method. In the Lomuto scheme, the worst case of the method occurs for a highly unbalanced partition (one of the sets has much more elements than the other one). Throughout this disclosure, we assume zero-indexing for all the arrays.

### 2. Multiple Pivots and Partial Quicksort

The goal of this section is two-fold. First, extend the classical Lomuto partitioning scheme to multiple pivots, thus allowing for execution of multiple comparisons in parallel (an idea particularly useful in settings when the comparisons are oblivious and thus, expensive). Second, present a partial version of quicksort suitable for applications to oblivious computations of percentiles and building histograms where saving on recursive calls are beneficial. Note that in these scenarios, full sorting methods are not needed.

The second goal is more technical and is motivated by the following three higher-level intuition remarks. First, unlike comparisons of real numbers in plaintext, oblivious comparisons (using in oblivious sorting) are more expensive and should be processed in batches (comparison vectors) that are as large as the computational setting allows for, in order to reduce the number of communication rounds. Second, the standard quicksort method makes two recursive calls to each of the two subarrays in the partition of the original array with respect to a chosen pivot. If possible, such recursive calls should be performed in parallel. To leverage parallelization and load balancing, one can add multiple pivots that will partition the array into more subarrays. Third, a binning method does not require full sorting of the input array. The typical example is computing the median with a quicksort-like procedure where one of the two recursive calls mentioned in the previous remark is not needed at all.

In order to get a more MPC-friendly method, it is worthwhile trying different variations of the classical Lomuto scheme. One idea is to partition the array into more than two sets by using more than one pivot. This requires a careful analysis of the impact of adding pivots and parallel comparisons on the average and worst case. We will always be bound by the maximal number of parallel comparisons. Since performing a large number of sequential oblivious comparisons might become a bottleneck, having more than one pivot can have a large impact (note that this is not an issue for plaintext quicksort since comparisons are not batched). In addition, revealing the results of the intermediate comparisons is only specific to secret-sharing schemes. A second idea is to perform a partial quicksort for questions that do not require the fully sorted array (such as the computation of binning via percentiles). This reduces the number of recursive calls.

2.1 Partial Quicksort

The basic motivation for partial quicksort is the problem of computing the median of an array: if we were to apply the method of FIG. 2B and if we are not interested in fully sorting the array, we only need to make one of the two recursive calls from lines 3 and 4 (the one containing the middle position of the array). For instance, if the pivot partitions the array into two subarrays of sizes that are ⅓ and ⅔ of the full array, respectively, one does not need the recursive call to the smaller set. This yields the simplest example of partial sort and the idea extends to binning via more general percentiles.

This leads to the concept of targets as the indices corresponding to the percentiles to be computed. The example with the median has only one target N/2; the deciles have 9 targets: N/10, 2N/10, . . . , 9N/10. More generally, given an interval I, we can assign a set of targets to this interval, that is, the boundary indices for the binning or histogram within this interval.

In the case we are only seeking to determine the values of the targets in an array, we need not sort the entire array. If v is the initial array of length N and if B is the number of buckets, we only care about extracting which array elements bracket each of the B−1 thresholds. Specifically, let v^{sorted} be the sorted array corresponding to v. We say that a method partially sorts v with respect to the B-percentile targets if it outputs an array \hat{v} that satisfies

$${\hat{v}}_{j ⌊ \frac{N}{B} ⌋} = {v}_{j ⌊ \frac{N}{B} ⌋}^{sorted} , ∀ j = 1 , … , B - 1$$

$${\hat{v}}_{j ⌊ \frac{N}{B} ⌋} \leq {\hat{v}}_{j ⌊ \frac{N}{B} ⌋ + i} \leq {\hat{v}}_{( j + 1 ) ⌊ \frac{N}{B} ⌋} , ∀ j = 1 , … , B - 1 , ∀ i = 0 , ⌊ \frac{N}{B} ⌋ - 1.$$

2.2 Multi-Pivot Partial Quicksort (MPPQ) in Detail

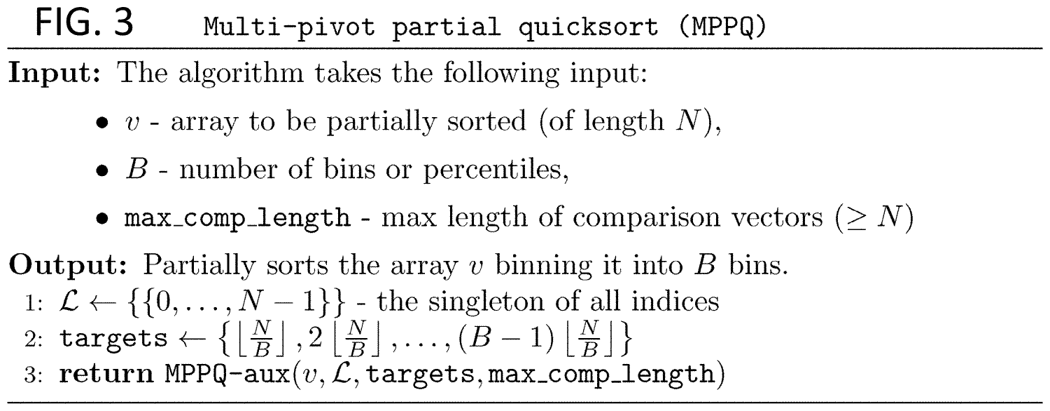

FIGS. 3-7 illustrate pseudocode for a plaintext MPC-friendly implementation of a partial quicksort with multiple pivots.

FIG. 3 illustrates the main procedure, referred to as Multi-pivot partial quicksort (MPPQ). The procedure takes as inputs the array v to be sorted and an integer B representing a number of bins or percentiles into which to partially sort the array. The technical input parameter max_comp_length represents a maximal number of comparisons that the multi-party computing system can perform as a batched set of comparisons. For convenience, this parameter should be greater than or equal to N, the length of the input array v to be sorted, but this is not strictly necessary.

At line 1, the procedure set a current list of intervals, L, to be the single interval including all of the indices of v. At line 2, the procedure sets a list of targets to be the indices that represent the boundaries of each of the B bins into which to sort the array. At line 3, the procedure calls the MPPQ-aux auxiliary recursive procedure.

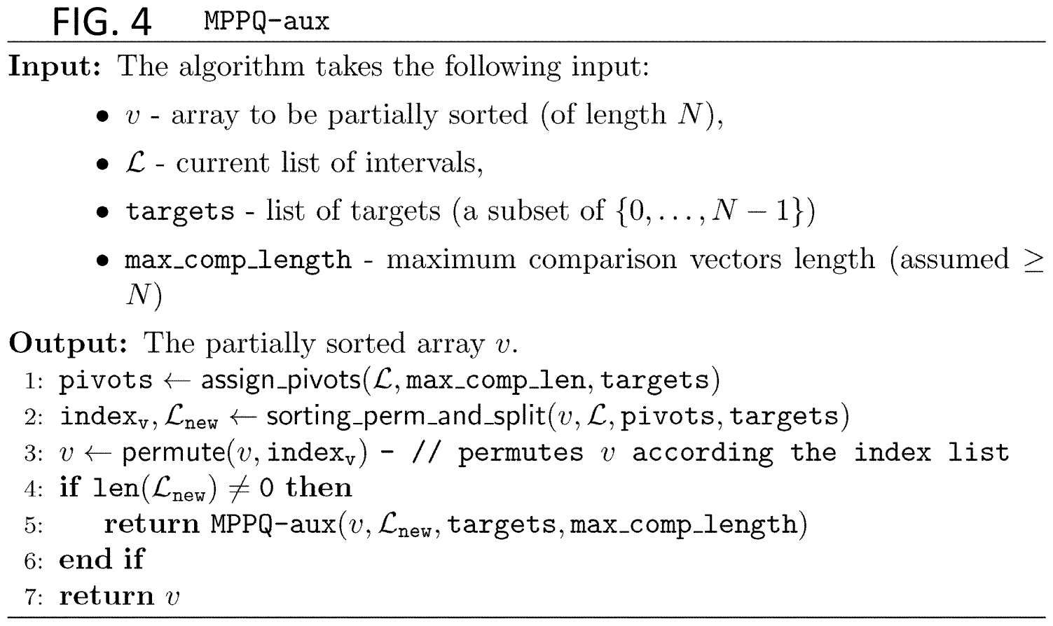

FIG. 4 illustrates the MPPQ-aux auxiliary recursive procedure. The auxiliary procedure takes as inputs the array v, a list of intervals L, a list of targets (or percentiles) and the technical input parameter max_comp_length. Each interval in the list of intervals can be specified, for example, by a pair of indices indicating its lower an upper bounds. The list of intervals identifies the sub-arrays that will be processed during the call of the procedure.

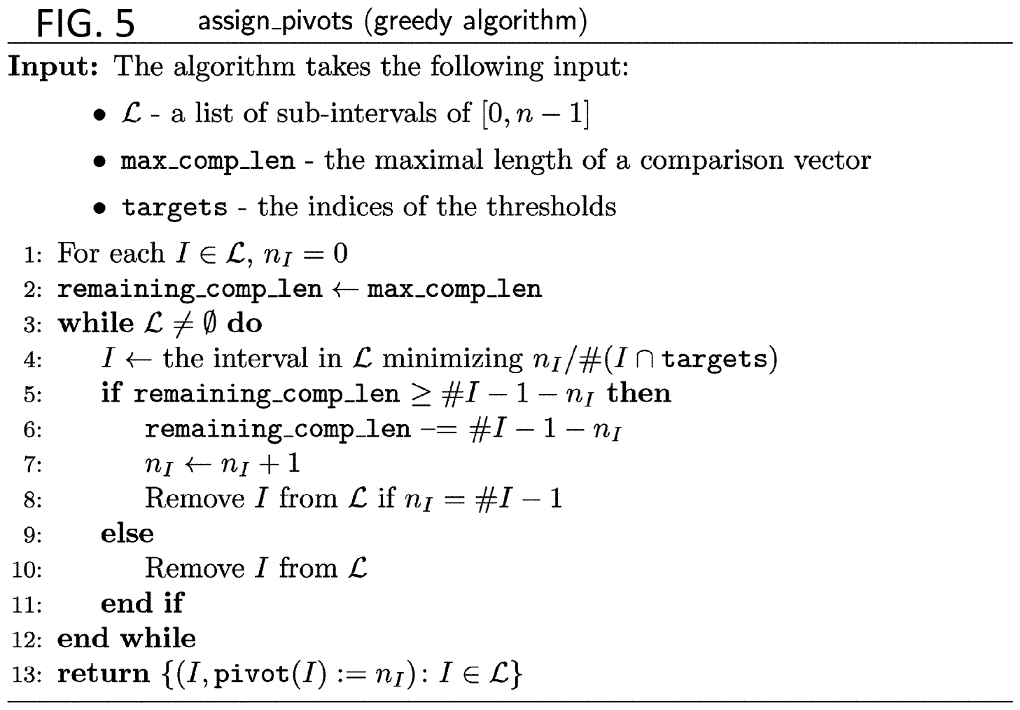

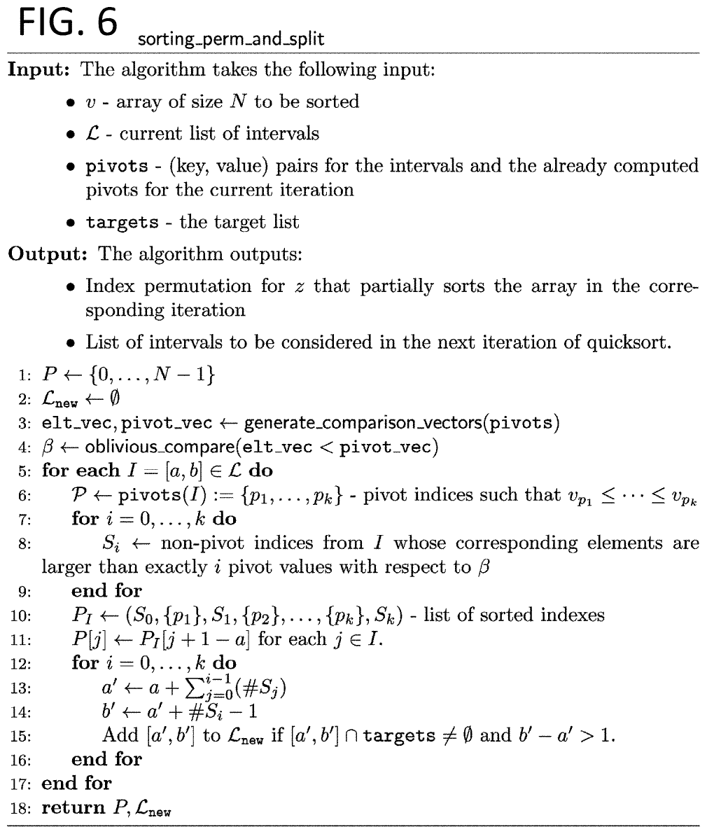

At line 1, the procedure uses the max_comp_length parameter to assign pivots to each interval as described below with reference to the assign_pivots procedure of FIG. 5. At line 2, the procedure calls sorting_perm_and_split, which is described below with reference to FIG. 6. The sorting_perm_and_split procedure will return a permutation of the array according to the current sorting, placing all pivots in their proper locations, as well as a new list of intervals for the next recursive call. At line 3, the procedure permutes the array v according to the permutation returned by the sorting_perm_and_split procedure. At lines 4-6, if there remain additional intervals to be processed in the new list of intervals, the procedure makes a recursive call to itself. At line 7, if there are no additional intervals to be processed, the procedure returns the permuted array v.

2.2.1 Assigning Pivots

FIG. 5 illustrates the assign_pivots procedure. This procedure takes as inputs a list of intervals L, the technical input parameter max_comp_length, and a list of targets. The procedure returns, for each interval in the input list, the set of pivots assigned to the interval. Each pivot can be returned in the form of a (key, value) pair, where the key identifies an interval, such as by its lower and upper bound indices, and the value identifies the pivot, such as by its index. It will be noted that the procedure of FIG. 5 can be implemented as a pure plaintext method that operates only on the public indices in the context of a multi-party computation.

Each interval in the list of intervals provided is assumed to include at least one target (e.g., an interval can have the median as a target, or the quantiles, or deciles as targets). The more targets we have in an interval, the closer the output of the partial sorting becomes to a full sorting. As will be discussed in Section II, below, batches of oblivious comparisons can be advantageously performed in parallel through the use of comparison vectors of multiple elements to be compared at the same time. Therefore, we try as best as we can to fill these comparison vectors to their maximal capacity. We use max_comp_length to represent the maximal comparison length of two vectors for an oblivious comparison.

Referring to FIG. 5, at line 1, the procedure sets the number of pivots n_{I} for each interval I to zero. At line 2, the procedure sets the variable remaining_comp_len equal to max_comp_length. Lines 3-12 bracket a while loop that iterates until the list of intervals is null.

At line 4, the current interval I is set to the interval having the smallest ratio of pivots/targets. This is done since the more targets we have in an interval, the more pivots we would like to use, and we call an interval relevant if it has at least one pivot. Our strategy is thus to assign at least one pivot to each relevant interval and then keep assigning pivots to intervals with a larger number of targets until we deplete the size of the comparison vectors max_comp_length. As lines 3-12 iterate, this will result in each interval being assigned at least one pivot.

At line 5, the procedure checks whether there are enough positions remaining in the comparison vector to include the necessary comparisons when another pivot is added to the current interval. In general, the more pivots we have in an interval, the more comparisons we need in the partial quicksort method since each pivot element in an interval will need to be compared to each non-pivot element. An interval I with n pivots would require n·len(I)−n(n+1)/2 comparisons.

Therefore, on line 5, the remaining_comp_len is compared to the number of indices in the current interval, #I, minus one, minus the current number of pivots assigned to the interval n_{I}. At line 6-7, if there is room available, the remaining_comp_len is decreased by the required number of comparisons and the number of pivots assigned to the interval is incremented. At line 8, if the number of pivots is equal to the number of indices in the current interval, #I, minus one, then the current interval is removed from the list of intervals L over which lines 3-12 iterate, since all possible comparisons for the interval are already being performed.

At line 10, in the case that the check performed in line 5 fails and there is not enough room to add a pivot, the current interval is also removed from the list of intervals L over which lines 3-12 iterate.

At line 13, the procedure returns, for each interval, an assignment of pivots to the interval based on the determined number of pivots n_{I}. The assignment of the actual pivots can be a trivial operation given the number of pivots n_{I}, such as selecting the first n_{I} indices of the interval as the pivots.

More generally we can characterize the procedure of FIG. 5 as follows.

Initially, assign each relevant interval I one pivot (i.e., n_{I}=1). In doing this we expect that the max_comp_length is sufficient to accommodate these comparisons as follows:

$${\sum }_{j = 1}^{s} {I}_{j} \leq max\_comp \_length + s .$$

In each iteration, we choose the interval I in the remaining collection of intervals with minimal n_{I}/#(I∩targets) and increase n_{I} by 1 as long as:

$${\sum }_{I ∈ ℒ} ( {n}_{I} \cdot ( I - {n}_{I} ) + \frac{{n}_{I} ( {n}_{I} - 1 )}{2} ) \leq max\_comp \_length$$

with the updated n_{I}. Here, the first term is the product of pivots x non-pivots, and the second term is the number of distinct pairs of pivots. Next, we remove I from L if either n_{I}=#I−1 or the maximal comparison length is exceeded. In sum, we first ensure that each relevant interval in the collection [symbol] will have at least one pivot. We then iterate, adding additional pivots, until we deplete the collection of intervals.

2.2.2 Sorting Permutations and Splitting the Intervals

FIG. 6 illustrates the sorting_perm_and_split procedure. This procedure takes as inputs the array v, the current list of intervals [symbol] , the assigned pivots for the current list of intervals, and the list of targets. The procedure returns a permutation of the array v according to the current sorting, placing all pivots in their proper locations, as well as a new list of intervals for the next recursive call.

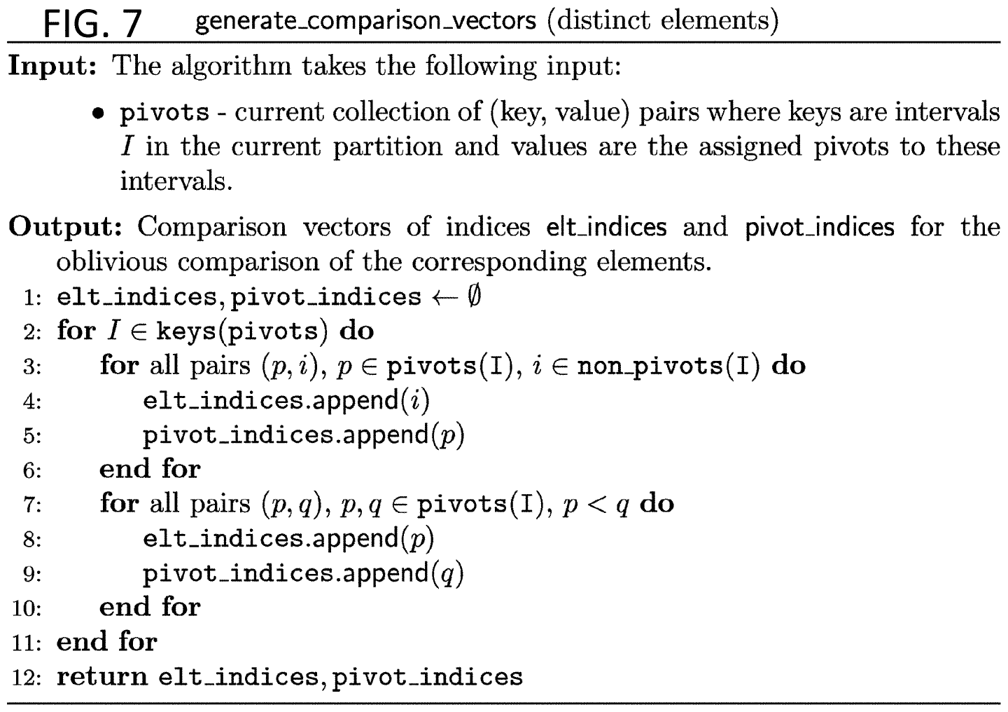

At line 1, the global permutation variable P is assigned the identity permutation. At line 2, a new list of intervals [symbol] _{new} is initialized to the empty set. At line 3, comparisons needed in this procedure are performed in batches, with batches (or comparison vectors) generated according to the generate_comparison_vectors procedure described with reference to FIG. 7. The generate_comparison_vectors procedure is called with the list of pivots from the assign_pivots procedure, to return a vector of element indices, elt_indices, and a vector of pivot indices, pivot_indices, identifying elements for comparison.

At line 4, an oblivious comparison procedure oblivious_compare, various implementations of which will be described in Section II below, is called to perform a comparison between the values of the array elements of the element and pivot vectors. The result of the comparison is a binary vector β representing the results of the comparisons of each pair of elements identified in the vectors. In an MPC setting, the binary vector β, can be revealed (in plaintext) to the individual party computing systems after each round or batch of comparisons.

Lines 5-17 bracket a for loop that iterates over each interval I of the current list of intervals [symbol] , where each interval can be defined by its lower and upper bound indices a and b, respectively. At line 6, based on the results of the comparison procedure, a list of the k pivots p₁ . . . pₖ for the current interval is assembled in sorted order.

Lines 7-9 bracket a for loop that iterates the count variable i over the k pivots for the current interval. At line 8, a list Sᵢ of non-pivot indices whose corresponding elements of v are larger than exactly i pivot values with respect to the comparison vector β is assembled.

At line 10, a permutation P_{I} for the interval I is assembled by interleaving the indices of the lists S₁ . . . Sₖ with the indices of the pivots p₁ . . . pₖ in order. At line 11, the permutation P_{I} for the interval I is integrated into the global permutation variable Pin its corresponding location.

Lines 12-16 bracket a for loop that iterates i over each of the k lists S₁ . . . Sₖ of remaining unsorted non-pivot indices. At line 12, the lower bound index a′ is determined, and at line 13, the upper bound index b′ is determined. At line 15, if the list of remaining unsorted non-pivot indices has more than one element and contains a target, it is added to the list of new intervals [symbol] _{new}.

At line 18, the procedure returns the current global permutation variable P and the new list of intervals [symbol] _{new}.

2.2.3 Generating Comparison Vectors for Arrays of Distinct Elements

FIG. 7 illustrates the generate_comparison_vectors procedure, which constructs comparison vectors of pairs of indices necessary for the partial sort with respect to the current pivots. This procedure takes as inputs a list of pivots, which can be represented as (key, value) pairs where the keys are intervals I in the current partition and the values are assigned pivots for the intervals. The procedure returns a vector of element indices, elt_indices, and a vector of pivot indices, pivot_indices, identifying elements of v for comparison. It will be noted that the procedure of FIG. 7 can be implemented as a pure plaintext method that operates only on the public indices in the context of a multi-party computation.

At line 1, the elt_indices and pivot_indices vectors are initialized to null. Lines 2-11 bracket a for loop that iterates over all of the intervals I for which pivots have been supplied.

Lines 3-6 bracket a nested for loop which iterates over all pairs of (p,i) in the interval I, where p is a pivot index and i is a non-pivot index. For each pair, p is added to the pivot_indices vector while i is added to the elt_indices vector in a corresponding location. In this manner, each pivot is compared with each non-pivot.

Lines 7-10 bracket a second nested for loop which iterates over all pairs of (p,q) in the interval I. In this manner, each pivot is compared with every other pivot in I. For each pair, q is added to the pivot_indices vector while p is added to the elt_indices vector (or vice versa) in a corresponding location.

At line 12, the procedure returns the elt_indices and pivot_indices vectors.

2.2.4 Comparison Vectors in the Case of Duplicate Elements

This MPPQ method is simpler in the case when all elements of the array are distinct. The method can be modified, however, to better handle duplicate elements in the array. For a pair (i,j) such that vᵢ=vⱼ, the result of the oblivious comparison will always be 0 which would mean that one has to always transpose this pair. This transposition will clearly be unnecessary in the sorting method and one would ideally like to avoid it. One way (in plaintext) to overcome this inefficiency would be to introduce a precedence operator [symbol] on the elements defined as follows: vᵢ [symbol] vⱼ if either 1) vᵢ<vⱼ or 2) i<j and vᵢ=vⱼ. One can then modify the oblivious comparison method to be able to compare with respect to this precedence operator. While this idea allows us to get rid of all unnecessary transpositions in the sorting method, it introduces security flaws: suppose that vᵢ=vⱼ for all i<j. In this case, we will always reveal 1 as a result of the comparison vᵢ [symbol] vⱼ and with high probability, will reveal that all elements of the array are equal.

Instead, we can use a trusted dealer to append distinct tags in random order to the elements of the array, in which case the MPPQ method can be performed as described above. To do this, it suffices that the dealer generates a uniformly random permutation of the indices {0, . . . , N−1} and appends these elements to {v₀, . . . , v_{N-1}}. Note that this will result in a more efficient method than the naïve one above since half of the time, when the predicate vᵢ<vⱼ is false but vᵢ=vⱼ, the method will not transpose the elements.

### 3. The MPPQ Method in an MPC Setting

In an MPC setting, we take as an input to the MPPQ procedure an array z that is secret shared among multiple party computing systems. The target list or number of bins is understood to be public. The MPPQ procedure can be then implemented as follows in an MPC setting.

A multi-party computing system can generate a secret random permutation σ of size N. In one embodiment, the secret random permutation can be generated by a trusted dealer or an honest-but-curious dealer, but other known methods can be used that do not require a dealer computer system.

The secret random permutation σ can be shared across or among the multiple party computing systems of the multi-party computing system. In one embodiment, the sharing is performed by the trusted dealer, which computes the Benes network of size N and the switch states for the permutation σ, secret sharing these switch states among the players. Other techniques for sharing a permutation, however, can be used, some of which may not require a dealer computer system.

The party computing systems can apply a to the input array z: v=σ∘z. The party computing systems can perform an MPPQ on v revealing at each iteration the comparison result vector β. The MPPQ can return the partially sorted array v and the permutation P that yields the sorting (P is public because the βs are public). Since P is the sorting permutation for σ∘z, we can apply P to the permutation σ to get π:=P∘σ as the sorting permutation for z. Applying the permutation π to z, the method returns (\hat{z},π) where \hat{z} is the partially sorted array and π:=P∘σ is the secret shared sorting permutation.

### 4. References

[1] Aumüller, M., Dietzfelbinger, M., Klaue, P.: How good is multi-pivot quicksort? (2016)
[2] Bogdanov, D., Laur, S., Willemson, J.: Sharemind: A framework for fast privacy-preserving computations. In: European Symposium on Research in Computer Security. pp. 192-206. Springer (2008)
[3] Carpov, S., Deforth, K., Gama, N., Georgieva, M., Jetchev, D., Katz, J., Leontiadis, I., Mohammadi, M., Sae-Tang, A., Vuille, M.: Manticore: Efficient framework for scalable secure multiparty computation protocols. Cryptology ePrint Archive, Report 2021/200 (2021)
[4] Chang, C., Melhem, R.: Arbitrary size benes networks. Parallel Processing Letters 07 (May 1997)
[5] Chida, K., Hamada, K., lkarashi, D., Kikuchi, R., Kiribuchi, N., Pinkas, B.: An efficient secure three-party sorting protocol with an honest majority. IACR Cryptol. ePrint Arch. 2019,695 (2019)
[6] Hamada, K., Kikuchi, R., lkarashi, D., Chida, K., Takahashi, K.: Practically efficient multi-party sorting protocols from comparison sort methods. In: International Conference on Information Security and Cryptology. pp. 202-216. Springer (2012)
[7] Jónsson, K. V., Kreitz, G., Uddin, M.: Secure multi-party sorting and applications. IACR Cryptol. ePrint Arch. 2011,122 (2011)
[8] Waksman, A.: A permutation network. Journal of the ACM pp. 159-163 (1968)

### II. OBLIVIOUS COMPARISONS

### 1. Introduction

An oblivious comparison method takes as input two secret shared numerical values x and y (e.g., integers or real numbers) and outputs a secret shared bit that is the result of the comparison of x and y (1 if x<y and 0 otherwise). The method uses secure multi-party computation (MPC), that is, a cryptographic method allowing multiple parties to evaluate a function while keeping the inputs private and revealing only the output of the function and nothing else.

In one embodiment, the method can be implemented using the XOR Secret Computing Engine developed by Inpher, adopting the full-threshold model for MPC throughout and splitting the computation into online and online phases. The offline phase (independent of the input data) can be performed by a trusted dealer or honest-but-curious dealer. Although the methods disclosed herein may in some cases be described with respect to the trusted dealer model, these methods can also be used with the honest but curious model.

### 2. Notation and Preliminaries

Definition 1 (secret sharing). If (G,+) is an abelian group, then an element x∈G is said to be secret shared among the k players P₁, . . . , Pₖ, if every player Pᵢ holds an xᵢ, such that x₁+x₂+ . . . +xₖ=x.

In most secret sharing protocols, the secret shares are assumed to satisfy additional statistical properties that ensure that no proper subset of the players learns any information about the secret x, even if they combine their secret shares. A data structure D represented as a string of bits

$$D = \overline{{d}_{0} … {- 1}_{}}$$

can be secret shared in two different ways as follows:
Arithmetic secret sharing scheme. We view D as an element of the abelian group G=( [symbol] / [symbol] [symbol] ,+) and secret-share it by uniformly drawing k−1 random elements x₂, . . . , xₖ from G and setting x₁=d−Σᵢ₌₂^{k}xᵢ(mod [symbol] )
Boolean secret sharing scheme. We view D as an array of bits of the abelian group G=( [symbol] / [symbol] [symbol] ,⊕) and secret share each bit dⱼ by choosing uniformly at random k−1 elements x₂, . . . , xₖ from [symbol] /2 [symbol] and setting x₁=dⱼ⊕ ⊕ᵢ₌₂^{k}xᵢ. As used here, the ⊕ operator denotes an exclusive OR (XOR) operation or equivalently bitwise addition modulo 2.

### 3. Evaluating Binary Gates

Let x be a boolean tensor. We use [symbol] x [symbol] _{⊕} to denote a k-tuple of tensors (x₁, . . . , xₖ) such that x₁⊕ . . . ⊕xₖ=x. If x₁, . . . , xₖ₋₁ are independent uniformly random tensors, we refer to [symbol] x [symbol] _{⊕} as secure boolean secret shares of x. We think of Boolean matrices as ordered sets of Boolean column vectors. Column vector operations are parallel and can be executed component-wise. In the following, we focus primarily on operations between single column matrices. Boolean sharing is the equivalent of additive sharing with coefficients over the field F₂ and as such, algorithms such as Beaver multiplication apply to this context as well.

3.1 XOR, Negation and Affine Combination

Both XOR and negation are operations that do not need precomputed triplets and thus, they can be performed without communication, each player operating directly on its secret shares. Let [symbol] x [symbol] _{⊕} and [symbol] y [symbol] _{⊕} be secret shares of two tensors x and y of the same dimension and let c be a constant public tensor of the same dimensions as x.
XOR: [symbol] x⊕y [symbol] _{⊕}= [symbol] x [symbol] _{⊕}+ [symbol] y [symbol] _{⊕} can be computed locally by each player, since the shares are in [symbol] /2 [symbol] .

Negation: [symbol] ¬x [symbol] _{⊕}=(¬x₁, . . . , xₖ). Only the first player negates its share, and all other players preserve their share. In particular, we emphasize that negation is NOT the opposite for the XOR law, in particular, [symbol] ¬x [symbol] _{⊕}≠¬ [symbol] x [symbol] _{⊕}. Instead, negation is similar to XOR-ing with a constant.
XOR with a constant: [symbol] x+c [symbol] _{⊕}=(x₁+c, . . . , xₖ). Only the first player adds the constant, while all other players preserve their shares.
   In the three cases, the secret shares of the result can be computed locally by each player, and if the initial shares were secure (that is, x₁, . . . , xₖ₋₁ are independent and uniformly random), so are the resulting shares.

3.2 Public-Private AND Operations

In this section, we assume that [symbol] x [symbol] _{⊕} is a set of boolean secret shares of a tensor x and y is a public tensor of the same dimensions. Then, by distributivity of AND on XOR, we have
[symbol] x AND y [symbol] _{⊕}= [symbol] x [symbol] _{⊕} AND y=(x₁ AND y, x₂ AND y, x₃ AND y, . . . , xₖ AND y)
   We may also extend this formula to negations of x or y:
[symbol] ¬x AND y [symbol] _{⊕}= [symbol] ¬x [symbol] _{⊕} AND y=(¬x₁ AND y, x₂ AND y, . . . , xₖ AND y)
[symbol] x AND ¬y [symbol] _{⊕}= [symbol] ¬x [symbol] _{⊕} AND ¬y=(x₁ AND ¬y, . . . , xₖ AND ¬y)
   Most importantly, every player negates public values like y, whereas only one player negates secret shared values.

3.3 Private/Private AND Operations and Extensions

We now show how a single mask-and-reveal of [symbol] x [symbol] _{⊕} and [symbol] y [symbol] _{⊕} is sufficient to allow for local computation of all binary operations with inputs [symbol] x [symbol] _{⊕} and [symbol] y [symbol] _{⊕}. This is achieved through the use of beaver-triplets. Furthermore, we provide a general formula for the most common binary gates (AND, OR, NAND, NOR) to optimize complex logic gates and reduce communication/memory complexity.

Assume that we have secret shares [symbol] x [symbol] _{⊕}, [symbol] y [symbol] _{⊕}, [symbol] λ [symbol] _{⊕}, [symbol] μ [symbol] _{⊕} and [symbol] λ AND μ [symbol] _{⊕} of five single-column Boolean matrices x, y, λ, μ, λ AND μ of same length. The two columns x,y correspond to the secret plaintext. During the offline phase, the dealer draws λ, μ uniformly at random, computes λ AND μ, secret shares [symbol] λ [symbol] _{⊕}, [symbol] μ [symbol] _{⊕} and [symbol] λ AND μ [symbol] _{⊕} and distributes the shares to the players. Thus, at the beginning of the online phase, each player only knows its own share of the five columns. As in the standard Beaver multiplication, the players first apply a mask-and-reveal in order to get the two masked values a=x⊕λ and b=y⊕μ.

Writing x AND y=(a⊕λ)AND(b⊕μ), note that secret shares of [symbol] x AND y [symbol] _{⊕} can be linearized via following formula:
[symbol] x AND y [symbol] _{⊕}= [symbol] λ AND μ [symbol] _{⊕}⊕( [symbol] y [symbol] _{⊕} AND b)⊕(a AND [symbol] μ [symbol] _{⊕})⊕(a AND b)
   With the same mask-and-revealed setting, we can also negate x,y or both, taking advantage of the fact that ¬x=λ⊕¬a:
[symbol] ¬x AND y [symbol] _{⊕}= [symbol] λ AND μ [symbol] _{⊕}⊕( [symbol] y [symbol] _{⊕} AND b)⊕(¬a AND [symbol] μ [symbol] _{⊕})⊕(¬a AND b)
[symbol] x AND ¬y [symbol] _{⊕}= [symbol] λ AND μ [symbol] _{⊕}⊕( [symbol] y [symbol] _{⊕} AND ¬b)⊕(a AND [symbol] μ [symbol] _{⊕})⊕(a AND ¬b)
[symbol] ¬x AND ¬y [symbol] _{⊕}= [symbol] λ AND μ [symbol] _{⊕}⊕( [symbol] y [symbol] _{⊕} AND ¬b)⊕(¬a AND [symbol] y [symbol] _{⊕})⊕(¬a AND ¬b)
   In other words, we can always evaluate linear gates XOR; XNOR locally, and as long as one beaver triplet has been computed for x and y, and both have been masked-and-revealed, we can evaluate not only x AND y locally (the traditional bitwise Beaver product over [symbol] ₂), but also any other binary gate OR, NAND, NOR, : : : .

3.4 Selectors

All circuits can be expressed in terms of AND, XOR and negations. On top of that the MUX, or selector gate augments the logic on a data dependent expression. This gate takes one selector predicate s and two outcomes x, y, and based on the bit value of s, it returns either x or y. By definition, we have MUX(s,x,y), also denoted by s ? x:y, equal to:
MUX(s,x,y)=(s AND x)⊕(¬s AND y).
   Note that we have
MUX(s,x,y)=(s AND x)⊕(¬s AND y)=y⊕(s AND (x⊕y)).
   Since the previous section shows how to evaluate AND, XOR and negations, this yield a straightforward way of evaluating selector gates on secret shares.

### 4 Low-Level Builtins

On the XOR Secret Computing Engine, the Boolean operations are enabled by several low-level builtins which we explain in detail, namely, BooleanExpression, MaskAndDecomp and BooleanToModReal.

4.1 BooleanExpression

The BooleanExpression builtin outputs an n X m boolean matrix where each of them output columns is a bit-wise expression of the input Boolean matrices. The BooleanExpression builtin consists of:
containerID—identifying the container for the output matrix;
a vector of m Statement(s) corresponding to them columns of the output matrix; and
pubCidSet—a list with the id(s) of the public containers (that is, containers known as public at compile time).

4.1.1 Statements

One column of the output is described by a Statement, which is either:
one Expression (introduced below); or
a select statement MUX(s(colS), e₁, e₂) for two Expression(s) e₁, e₂ based on a selector column s(colS) of a public container.

4.1.2 Expressions

The expression Expression, up to one optional global negation, is the XOR of a list of terms where each term can be:
And-term:(negX⊕x(colX)) AND (negY⊕y(colY))
Single-term:(negX⊕x(colX))
   Here, x(colX) means the column number colX of the matrix x, which is referenced by its absolute containerID. negX⊕x(colX) leaves the possibility to negate this column whenever negX is true.

The value of the output container is obtained column by column by evaluating the corresponding statement. When all containers listed in the statements are public, the output container is public. Else, the output container is secret shared. In the latter case, the formulas to compute the And-term and Single-term are given in Section 3.3.

4.1.3 The Statement Grammar

To be complete, this is the exact grammar of a valid Statement.

### Statement:=Selector|Expression

Selector:=(cId, colInd), Expression, Expression
Expression:=neg, vector<Term>

### Term:=AndTerm|SingleTerm

### AndTerm:=SingleTerm, SingleTerm

SingleTerm:=(neg, cId, colInd)

4.2 MaskAndDecomp

The builtin MaskAndDecomp takes as input a vector (of size n) of secret shared real numbers and returns an n-by-m Boolean matrix of the bit-wise decomposition of the numbers (that is, it assumes the use of an m-bit numerical window to represent each real number). The bitwise decomposition is performed with the help of precomputed data from the trusted dealer. As such, the output of the builtin consists of a public n-by-m Boolean matrix C (the masked value in the real number representation) and a secret shared n-by-m boolean matrix A (the mask for the real number representation).

The reason why we need both C and ∧ as opposed to just (boolean) secret shares of the resulting boolean matrix corresponding to x is the oblivious comparison methods described below. For example, steps 3. and 5. in Method 1 use both C and ∧ (in other words, we are using secret shares and not garbled circuits). The idea is that we cannot simply decompose a secret shared number by doing bit-wise decomposition locally as the latter would not yield Boolean secret shares of the bit-wise decomposition of the input vector. Note that we need to return the two Boolean matrices (the public C and the secret shared A) precisely because the masking operation is on real numbers and not on Boolean matrices.

Letting λ and c be the real number representation of the mask and the masked value, respectively, and the upper-case letters A and C be the corresponding boolean matrices for the bitwise decomposition, and letting lsb and msb be the positions of the least and most-significant bits, respectively, C, and a Boolean matrix ∧, of same visibility as x, such that we have

$$( c + λ ) {2}^{1 sb} = x ( mod {2}^{m s b} )$$

$$where$$

$${\sum }_{j = 0}^{m s b - 1 s b - 1} C ( : , j ) {2}^{j} = c ,$$

$${\sum }_{j = 0}^{m s b - 1 s b - 1} Λ ( : , j ) {2}^{j} = λ ,$$

As used herein lsb and msb correspond respectively to the parameters mMsb and pLsb as set out in U.S. patent Ser. No. 11/050,558, referenced above.

The builtin MaskAndDecomp consists of:
two output container ID(s)—one identifying the public container for the Boolean matrix C and one identifying the private (secret shared) container for the boolean matrix A;
pubCidSet—a list with the id(s) of the public containers (that is, containers known as public at compile time);
one input containerID for the input vector of real numbers (of size n);
parameters msb and lsb used in the bitwise representation of the real numbers. Finally, if the input vector x is a secret shared vector of real numbers then the offline phase of the builtin generates and secret shares a real mask λᵣₑₐₗ for the input. Furthermore, this mask gets negated and then converted to its Boolean representation λ_{⊕}. Finally the builtin generates secret shares of λ_{⊕} and adds them to the output container for A.

4.3 BooleanToModReal

This builtin should normally convert a Boolean matrix X of dimensions n x m to a vector z of size n of modular real numbers such that

$${z}_{i} = {2}^{1 s b} {\sum }_{j = 1}^{m} {X}_{i , j} {2}^{j - 1} , ∀ i = 1 , … n .$$

For comparisons as well as computations of the max and min functions, we can restrict to the case m=1 (in this case, it is still important to convert a Boolean value to a modular real number as one would use the formula max(x,y)=x+p(y−x) where p is the predicate x≤y).

In this particular case, if the vector X is private, then the builtin masks and reveals ∧:=X⊕∧ where ∧ is a uniformly random Boolean vector of size n. Furthermore, the players hold secret shares of the ModReal vector W:=2^{1sb}∧ (computed by the dealer in the offline phase). For i=1, . . . , n, one then has

$${z}_{i} = \{ \begin{matrix}{W}_{i} & if X ⊕ Λ = 0 , \\ {2}^{1 sb} - {W}_{i} & else .\end{matrix}$$

### 5. Oblivious Comparison Methods

Using the foregoing as building blocks, various methods for obliviously comparing two secret shared numerical values will now be described.

5.1 Defining Comparison for [symbol] /

[symbol]

We define comparison for the group ( [symbol] / [symbol] ,+) as a means of comparing signed integers in the usual way: if x∈ [symbol] / [symbol] , we denote by x̅ the corresponding representative in {− [symbol] , . . . , [symbol] } (we call this lift x̅ the centered modular lift). By abuse of notation, given x∈ [symbol] / [symbol] , we also denote by x the standard lift (that is, the unique integer in {0, 1, . . . , [symbol] −1} that is x modulo [symbol] ).

For any two elements x, y∈ [symbol] / [symbol] , we say that x>y if and only if x̅>y̅. According to this definition, an element x E {0, 1, . . . , [symbol] −1} is considered negative if the most significant bit is 1 and is considered positive otherwise.

5.2 The General Method

Several comparisons can be determined in parallel by taking two vectors or arrays of numbers to be compared, rather than taking single values to be compared. This implementation also supports single value comparisons in the case of a vector or array of dimension one. In one embodiment, we take as input two vectors a and b of i-bit signed integers (meaning that the plaintext values are [symbol] bits). Assume we represent the signed numbers in plaintext in

{− [symbol] , . . . , [symbol] −}

as elements of [symbol] / [symbol] . This representation has a drawback that x>y does not imply that (x−y)>0. Since we would like to make use of the latter in the oblivious comparison method (to get the Boolean value of the comparison out of the most significant bit of x−y), we look for a different representation.

It turns out that representing the [symbol] -bit signed numbers as the subset

S:={0, . . . , [symbol] }∪{ [symbol] − [symbol] , . . . , [symbol] −1}⊂{0, . . . , [symbol] −1}

has the desired property, namely that x>y⇒(x−y)>0. Let [symbol] = [symbol] +1. We assume that the numbers are arithmetically secret shared in the larger group G=( [symbol] / [symbol] ,+). The output of the computation is an arithmetic secret shared vector β in ( [symbol] / [symbol] ,+), such that the ith entry of β is 1 if the ith entry of b is greater than the ith entry of a and 0 otherwise.

Representing z as a string of [symbol] bits, this condition is equivalent to the condition of the most significant bit of z being zero. Therefore we can compare the two vectors a and b by calculating c=a−b and then extracting the vector of the most significant bits of c. The calculation of c is trivial. In fact, each player Pᵢ already holds a vector of arithmetic secret shares aᵢ of a and bᵢ of b. So each player calculates a vector of arithmetic secret shares cᵢ of c as cᵢ=aᵢ−bᵢ.

The extraction of the most significant bit of c is less obvious as there is a non-linear dependency between the vector of the most significant bits of c and the matrix of bits of the secret shares of c. For that, we will use precomputed masking data from the dealer. Given a masking vector λ that is arithmetically secret shared among the players and given Boolean secret shares of its negated counterpart λ′=−λ; the players can extract the vector of most significant bits of c via the following method:

1. Mask and reveal the vector t=c+λ over [symbol] / [symbol]
2. Decompose each entry oft into its boolean representation, so that players know the plaintext vectors t₀, . . . , [symbol] ₋₁, where vector tᵢ corresponds to the vector of bits of t at position i.
3. Using the Boolean secret shares of λ′, the players can execute a bit-wise addition of λ′ to t and end up with boolean secret shares of c.
4. The players extract the Boolean shares of the vector of the most significant bits of c. They either set β to this vector or they lift it to arithmetic shares in another group.

5.3 The Naïve Implementation

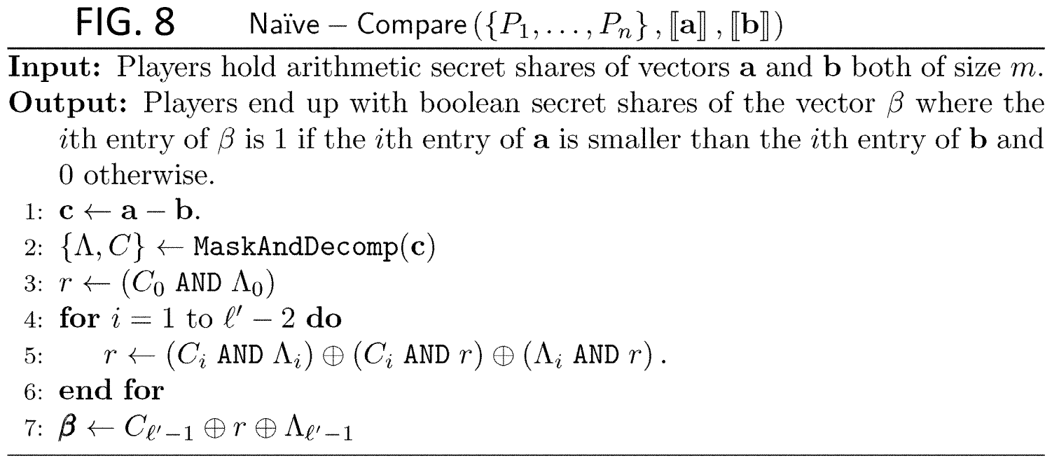

FIG. 8 illustrates pseudo-code for a naïve implementation of the above oblivious comparison method. The function MaskAndDecomp refers to the above special-purpose built-in that masks and reveals input c, decomposes c into its boolean representation C and distributes Boolean secret shares of λ′; which we will denote by ∧ (steps 1 and 2 above). Note that the rows of a Boolean matrix correspond to the bit-string representation of a number, whereas the columns correspond to the vector of bits at the same position in the bit-string. Whenever we index a Boolean matrix, we reference to the corresponding column (the vector of bits at the same position). C can thus be represented as the concatenation of vectors C₀|C₁| . . . | [symbol] .

Referring to FIG. 8, at line 1, the secret shared number b is subtracted from the secret shared number a to obtain the secret shared number c. At line 2, the secret shared number c is masked and decomposed in a multiparty computation into the public Boolean matrix C and a secret shared Boolean mask matrix ∧. At line 3, the 0^{th} bits of each row of the C and ∧ matrices are ANDed together to produce a secret shared Boolean vector r which used to store a carry bit as additional bits are evaluated.

At line 4, a for loop iterates the index i over the values 1 to [symbol] −2 to process the additional bits of the matrices. At line 5, which is executed in each iteration of the for loop, the vector r is assigned to the value of an expression that evaluates to the value of the carry bit for the sum of: the Boolean vales Cᵢ, ∧ᵢ, and the prior Boolean value of r. Line 6 closes the for loop.

At line 7, the carry from the next to last bit is represented by the secret shared vector r, which is effectively summed modulo 2 in a multiparty computation with the last bits of C and ∧, to produce the Boolean secret shares of the most significant bit of c.

It will be noted that the determination of (∧ᵢ AND r) on line 5 involves a Beaver multiplication modulo 2 of the vectors ∧ᵢ and r, which requires one round of communication between the parties. Note that all the multiplications for each iteration of the index i can be performed using the same round of communications, but each iteration of the for loop requires a separate round of communication. Accordingly, for example, in comparing vectors of 128 bit arithmetic secret shared inputs, approximately 128 rounds of communication would be required.

5.4 The Divide and Conquer Implementation

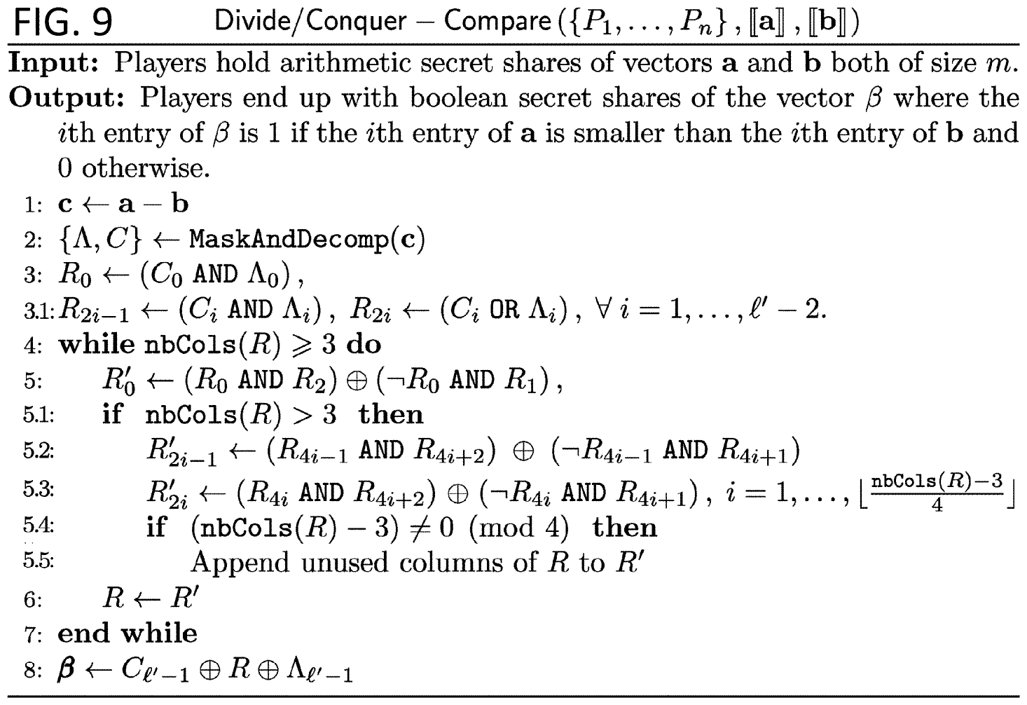

FIG. 9 illustrates a divide and conquer implementation of the oblivious comparison method. In the illustrated divide and conquer implementation, the number of rounds of communication is reduced to order (log( [symbol] )) from order ( [symbol] ) in the naïve implementation. Lines 1 and 2 of FIG. 9 mirror those of FIG. 8.

At line 3, a first column R₀ of a temporary matrix R is assigned to C₀ AND ∧₀, which evaluates to the first bit of the bitwise addition of C and ∧ resulting in a carry to the next bit. At line 3.1, we evaluate and store the values of two expressions for each column i through the remainder of the bits except the last. We evaluate (Cᵢ AND ∧ᵢ), which indicates that there will definitely be a carry from column/bit i. We also evaluate (Cᵢ OR ∧ᵢ), which indicates that there will be a carry if there is also a carry from the prior column i−1. In the implementation of FIG. 9, the values of these two expressions are stored in adjacent pairs of columns in the temporary matrix R for the indices 1 up to [symbol] −2. In additional or alternative embodiments, the values stored in the matrix R from the two expressions above could alternatively be stored in separate matrices or other separate or unified data structures depending on implementation.

At line 4, a while loop evaluates the number of columns in R using the function nbCols, and if the number of columns is at least three, then the body of the while loop is executed. The while loop is bracketed by an end while at line 7.

At line 5, a first column R′₀ of a second temporary matrix R′ is assigned to the output of a selector expression that depends on the value of R₀, which was assigned in line 3 to hold the carry result of the first bit of the bit-wise addition. Depending on whether the carry bit is 1 or 0, determines whether we look to the first or the second evaluated expression determined in line 3.1. If the carry bit is 1, then R₁, which is the OR of the next bit of the two addends, determines whether there is yet another carry to the next column. If the carry bit is 0, then R₁ determines whether there is yet another carry to the next column. The result of line 5 on a first iteration of the while loop is that the carry bit resulting from the bit-wise addition of both columns 0 and 1 of has now been collapsed down into column R′₀ of the second temporary matrix.

At line 5.1 an if statement evaluates whether the number of columns in R is greater than three. If so, then the next two lines 5.2 and 5.3 will iterate over the index i to evaluate successive groups of four columns of the matrix R (which correspond to two columns of the matrices C and ∧ on a first iteration), to collapse those four columns down to two columns in the matrix R′. The groups of four columns that are evaluated are based the floor function evaluation at the end of line 5.3 that sets the range of the index i. The evaluation of the expressions on lines 5.2 and 5.3 operate similarly to the selector expression on line 5, but do so to create two new columns in the matrix R′ representing the equivalent of the AND and OR expressions evaluated on line 3.1.

At line 5.4, an if statement determines if any remaining columns of R were not processed in lines 5.2 and 5.3 are then at line 5.5 appends those remaining columns to R′ for further processing on a next iteration of the while loop. At line 6, the matrix R′ is assigned to replace the former matrix R and the while loop iterates again until there is only one column left in R.

At line 8, the carry from the next to last bit is represented by the single column secret shared matrix R, which is effectively summed modulo 2 in a multiparty computation with the last bits of C and ∧, to produce the Boolean secret shares of the most significant bit of c.

In the divide and conquer implementation of FIG. 9, each iteration of the while loop haves the number of columns remaining to process and so the while loop will iterate an order (log( [symbol] )) times. Although there are several multiparty computations within the while loop (six in the illustrated example), each of the computations is independent of the others, and so all of them can be performed using a single round of communication between parties in the multiparty computation system.

### III. COMPUTER IMPLEMENTATION

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include one or more standalone, client and/or server computers, which can be optionally networked through wired and/or wireless networks as a networked computer system.

The special purpose software can include one or more instances thereof, each of which can include, for example, one or more of client software, server software, desktop application software, app software, database software, operating system software, and driver software. Client software can be configured to operate a system as a client that sends requests for and receives information from one or more servers and/or databases. Server software can be configured to operate a system as one or more servers that receive requests for and send information to one or more clients. Desktop application software and/or app software can operate a desktop application or app on desktop and/or portable computers. Database software can be configured to operate one or more databases on a system to store data and/or information and respond to requests by client software to retrieve, store, and/or update data. Operating system software and driver software can be configured to provide an operating system as a platform and/or drivers as interfaces to hardware or processes for use by other software of a computer or computer system. By way of example, any data created, used or operated upon by the embodiments disclosed herein can be stored in, accessed from, and/or modified in a database operating on a computer system.

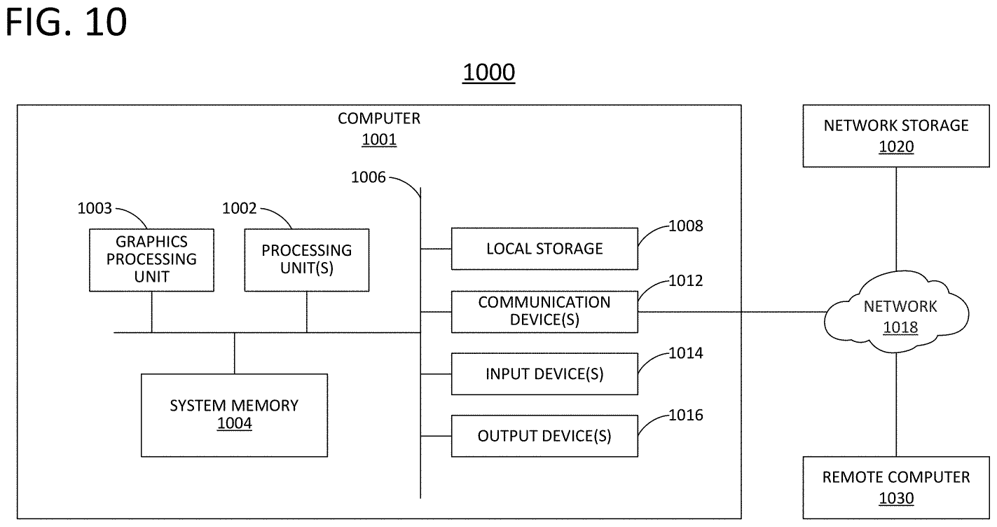

FIG. 10 illustrates a general computer architecture 1000 that can be appropriately configured to implement components disclosed in accordance with various embodiments. The computing architecture 1000 can include various common computing elements, such as a computer 1001, a network 1018, and one or more remote computers 1030. The embodiments disclosed herein, however, are not limited to implementation by the general computing architecture 1000.

Referring to FIG. 10, the computer 1001 can be any of a variety of general purpose computers such as, for example, a server, a desktop computer, a laptop computer, a tablet computer or a mobile computing device. The computer 1001 can include a processing unit 1002, a system memory 1004 and a system bus 1006.

The processing unit 1002 can be or include one or more of any of various commercially available computer processors, which can each include one or more processing cores that can operate independently of each other. Additional co-processing units, such as a graphics processing unit 1003, also can be present in the computer.

The system memory 1004 can include volatile devices, such as dynamic random access memory (DRAM) or other random access memory devices. The system memory 1004 can also or alternatively include non-volatile devices, such as a read-only memory or flash memory.

The computer 1001 can include local non-volatile secondary storage 1008 such as a disk drive, solid state disk, or removable memory card. The local storage 1008 can include one or more removable and/or non-removable storage units. The local storage 1008 can be used to store an operating system that initiates and manages various applications that execute on the computer. The local storage 1008 can also be used to store special purpose software configured to implement the components of the embodiments disclosed herein and that can be executed as one or more applications under the operating system.

The computer 1001 can also include communication device(s) 1012 through which the computer communicates with other devices, such as one or more remote computers 1030, over wired and/or wireless computer networks 1018. Communications device(s) 1012 can include, for example, a network interface for communicating data over a wired computer network. The communication device(s) 1012 can include, for example, one or more radio transmitters for communications over Wi-Fi, Bluetooth, and/or mobile telephone networks.

The computer 1001 can also access network storage 1020 through the computer network 1018. The network storage can include, for example, a network attached storage device located on a local network, or cloud-based storage hosted at one or more remote data centers. The operating system and/or special purpose software can alternatively be stored in the network storage 1020.

The computer 1001 can have various input device(s) 1014 such as a keyboard, mouse, touchscreen, camera, microphone, accelerometer, thermometer, magnetometer, or any other sensor. Output device(s) 1016 such as a display, speakers, printer, or eccentric rotating mass vibration motor can also be included.

The various storage 1008, communication device(s) 1012, output devices 1016 and input devices 1014 can be integrated within a housing of the computer, or can be connected through various input/output interface devices on the computer, in which case the reference numbers 1008, 1012, 1014 and 1016 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs).

### IV. CONCLUSION

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow.

In the claims, the terms “based upon” and “based on” shall include situations in which a factor is taken into account directly and/or indirectly, and possibly in conjunction with other factors, in producing a result or effect. In the claims, a portion shall include greater than none and up to the whole of a thing; a subset can be either a proper or an improper subset.

1. A method for performing a sorting operation on a secret shared array z of values, the array z having N elements, the method performed by a secure multi-party computing system configured for performing multi-party computations on secret shared values, the secure multi-party computing system comprising a plurality of party computing systems in secure networked communication, the method comprising:
each of the party computing systems storing a respective secret share of the array z;
generating a secret random permutation σ of size N;
secret sharing the secret random permutation σ across the party computing systems;
the party computing systems applying the secret random permutation σ to the array z to obtain a permuted secret shared array v;
the party computing systems performing a set of operations on the array v to produce a public sorting permutation P of the permuted secret shared array v, the set of operations including multi-party computations;
the party computing systems applying the public sorting permutation P to the secret random permutation σ to obtain a secret shared sorting permutation π; and
the party computing systems applying the secret shared sorting permutation π to the array z; to obtain an array \hat{z} representing the array z permuted according to the sorting operation.

2. The method of claim 1, further comprising:
accessing a maximum comparison quantity representing a maximum quantity of pairs of secret shared values configured to be simultaneously compared by the multi-party computing system through an oblivious comparison process,
wherein the set of operations comprises a subset of operations comprising:
for a set of one or more intervals I, wherein each interval I represents a portion of the array v, determining, based on the maximum comparison quantity, a quantity of pivots n_{I} for each interval I; and
for at least one of the set of intervals I:
selecting a set of pivots from the interval I based on the determined quantity of pivots n_{I};
selecting a set of non-pivots by excluding the selected set of pivots from the interval I;
performing oblivious comparisons of:
each of the set of pivots with each of the set of non-pivots, and
each of the set of pivots with all others of the set of pivots; and
based on the oblivious comparisons, determining a permutation P_{I} of the elements of the interval I that places:
each of the pivots is in its proper sorted location within the array v, and
each of the non-pivots among a contiguous group of non-pivots interleaved adjacent one or two pivots within the array v, wherein all members of the contiguous group bear a common comparison relationship to each adjacent pivot.

3. The method of claim 2, wherein for at least one particular interval of the set of one or more intervals I, the determined quantity of pivots n_{I} for the particular interval represents all elements of the particular interval, and wherein the subset of operations further comprises, for the particular interval:
selecting all elements of the particular interval as a set of pivots;
performing oblivious comparisons of:
each of the set of pivots with all others of the set of pivots; and
based on the oblivious comparisons, determining a permutation P_{I} of the elements of the interval I that places:
each of the pivots is in its proper sorted location within the array v.

4. The method of claim 2, wherein the set of operations further comprises:
iterating, one or more times, the subset of operations wherein each interval I of a current iteration represents a contiguous group of non-pivots from a prior iteration.

5. The method of claim 4, wherein the set of one or more intervals I represents a proper subset of the set of contiguous groups of non-pivots from a prior iteration.

6. The method of claim 5, wherein the sorting operation is a partial sorting operation that does not fully sort the array z.

7. The method of claim 6, wherein the permutation π produced by the partial sorting operation places elements for a set of one or more target indices of the array z in their proper locations in the partially sorted array \hat{z}.

8. The method of claim 7, wherein the target indices are determined based on an input parameter defining a quantity of substantially equally sized segments into which the array v can be divided.

9. The method of claim 8, further comprising:
in response to determining that a particular contiguous group of non-pivots from a prior iteration does not contain at least one target index, excluding the particular contiguous group of non-pivots from the set of one or more intervals I of a current iteration.

10. The method of claim 1, wherein the secret sharing of the secret random permutation σ across the party computing systems is performed using a Benes network.

11. The method of claim 1, wherein the secure multi-party computing system further comprises a dealer computing system that performs:
generating a secret random permutation σ of size N; and
secret sharing the secret random permutation σ across the party computing systems.

12. The method of claim 2, wherein each of the oblivious comparisons comprises the secure multi-party computing system determining a secret shared indication of whether a secret shared numerical value a is less than a secret shared numerical value b, wherein multiple comparisons are performed simultaneously in a set of up to the maximum comparison quantity of comparisons, and wherein the secret shared indications are revealed after each set of comparisons.

13. The method of claim 12, wherein the determining a secret shared indication comprises:
each of the party computing systems storing a respective secret share of each of the values a and b;
each of the party computing systems subtracting its secret share of b from its secret share of a to compute a respective secret share of a secret shared numerical value c;
performing a first set of multiparty computations in order to decompose the secret shared numerical value c into a public Boolean array of bits C, representing the value c in a masked Boolean form, and a secret shared Boolean array ∧ representing a mask for the array C;
each of the party computing systems determining and storing a secret shared Boolean array of bits R, the array R comprising results of a bitwise (C OR ∧) operation performed on portions of the arrays C and ∧;
performing a second set of multiparty computations sufficient to execute a bit-wise addition of the array ∧ to the array C using the array R, wherein the bit-wise addition propagates carry bits from less significant bit positions to more significant bit positions up to a most significant secret shared bit; and
each of the party computing systems storing a respective secret share of the most significant secret shared bit as the secret shared indication.

14. The method of claim 13, wherein the second set of multiparty computations is performed using fewer rounds of communication than a total number of bits in the array C.

15. The method of claim 13, wherein the second set of multiparty computations is performed using order log(total number of bits in the array C) rounds of communication.

16. A method for determining a secret shared indication of whether a secret shared numerical value a is less than a secret shared numerical value b, the method being performed by a secure multi-party computing system configured for performing multi-party computations on secret shared values, the secure multi-party computing system comprising a dealer computing system and a plurality of party computing systems in secure networked communication, the method comprising:
each of the party computing systems storing a respective secret share of each of the values a and b;
each of the party computing systems subtracting its secret share of b from its secret share of a to compute a respective secret share of a secret shared numerical value c;
the dealer computing system and the plurality of party computing systems performing a first set of multiparty computations in order to decompose the secret shared numerical value c into a public Boolean array of bits C, representing the value c in a masked Boolean form, and a secret shared Boolean array ∧ representing a mask for the array C;
each of the party computing systems determining and storing a secret shared Boolean array of bits R, the array R comprising results of a bitwise (C OR ∧) operation performed on portions of the arrays C and ∧;
the dealer computing system and the plurality of party computing systems performing a second set of multiparty computations sufficient to execute a bit-wise addition of the array ∧ to the array C using the array R, wherein the bit-wise addition propagates carry bits from less significant bit positions to more significant bit positions up to a most significant secret shared bit; and
each of the party computing systems storing a respective secret share of the most significant secret shared bit as the secret shared indication.

17. The method of claim 16, wherein the second set of multiparty computations is performed using fewer rounds of communication than a total number of bits in the array C.

18. The method of claim 16, wherein the second set of multiparty computations is performed using order log(total number of bits in the array C) rounds of communication.

19. The method of claim 16, wherein the dealer is a trusted dealer.

20. The method of claim 16, wherein the dealer is an honest but curious dealer.
